(19) United States
(12) Patent Application Publication
(10) Pub. No.: US 2005/0056711 A1
(43) Pub. Date: Mar. 17, 2005

(54) Multiple spray nozzle appartus

(76) Inventor: Thomas R. Mee III, Pasadena, CA (US)

Correspondence Address: CHRISTIE, PARKER & HALE, LLP, PO BOX 7068, PASADENA, CA, 91109-7068, US

(21) Appl. No.: 10/662,658

(22) Filed: Sep. 15, 2003

Related U.S. Application Data
(60) Provisional application No. 60/410,968.

(51) Int. Cl. B05B 1/14

(52) U.S. Cl. 239/565

(57) ABSTRACT

A tube nozzle is constructed of a plurality of holes through the wall of a tube. Each hole may be in the range of from about 10 to 200 micrometers in diameter. Each hole may have a length through the wall in the range of from about 20 to 400 micrometers. The wall of the tube may be locally thinned where the holes are located so that flow losses due to friction and turbulence are minimized and so that the tube maintains sufficient mechanical integrity so as to be capable of delivering water under high pressure to the holes.

### CROSS-REFERENCE TO RELATED APPLICATION(S)

This application claims the benefit of U.S. Provisional Patent Application No. 60/410,968 the content of which is hereby incorporated by reference.

### FIELD OF THE INVENTION

This invention relates to nozzles in tubing to produce very small droplets of fog.

### BACKGROUND OF THE INVENTION

There are numerous sites where high-pressure, water atomization system (generally called fogging systems) are installed inside air ducts for purposes of building HVAC humidification, or gas turbine inlet air cooling, for example. There are several makers of high pressure fogging systems in the USA today. Such systems generally comprise a water treatment system including a filter, a high pressure pump, typically operating from about 500 to 3000 psi, and a series of atomization nozzles connected to the pump by feed lines.

Most of these installations of fog systems in air ducts have a very limited amount of time for the evaporation process to take place because of the rapidly moving air and limited space in the ducts. Typically the time available for evaporation is less than two seconds, and, in very high velocity ducts, it is often less than half a second before the air enters a turbine compressor, mist eliminator or other apparatus.

In most cases, it is quite desirable that all or nearly all of the water injected as droplets evaporates so that no liquid water remains in the airstream. In some air conditioning (HVAC) ducts full evaporation does not occur, and droplet eliminators are commonly placed to remove most or all of the droplets that have not yet evaporated. Water collected on such droplet eliminators must ordinarily be drained away to waste since treating and reusing the waste water is often too expensive. In gas turbine inlet ducts, there is often fallout of droplets on the duct floor and/or impaction of unevaporated fog on structures and surfaces in the ducts. Drain water flow rates currently range from less than 2% to more than 10% of injected water. It is desirable to minimize such waste water and to reach as close to 100% relative humidity as possible in the limited time available. For gas turbine fogging applications it is often desirable to evaporate all the fog before it enters the gas turbine compressor section or to have droplets that are as small as possible when they enter the compressor.

In order to get water to evaporate quickly, it is important to make very small droplets and to fully mix them with the airstream as quickly as possible. Evaporation occurs only at the water-air interface and smaller droplets, because they are spheres, provide a much higher surface area to mass ratio. Nozzles which produce droplets primarily in the range of from 10 to 30 microns are typically used for in-duct fogging. Air infused with water having such droplet sizes may be referred to as fog.

A typical installation has a plurality of stainless steel nozzles attached to manifold pipes distributed across the air duct. Each of the nozzles has a small diameter orifice (e.g. about 0.005 to 0.02 inch, 125 to 500 micrometers) and an impact pin against which a jet of water from the orifice impacts. Water is introduced through the manifold at operating pressures from several hundred psi to 3,000 psi. The resulting high velocity jet of water from the orifice is shattered into a multitude of fine droplets when it encounters the impact pin. Other nozzle designs have impact plates and still others have means for causing the jet of water to swirl as it exits the orifice, so that it forms an expanding cone of water, which then breaks up into tiny droplets. (Such nozzles are generally referred to as “swirl-jet” type nozzles.)

These nozzles are put into the manifolds and distributed as evenly as possible across the air duct so that the fog spray is mixed as evenly as possible with the airflow and as much as possible of the air is humidified. In practice, with the nozzles that are commercially available today, it is usually not possible to cover the entire air flow. The output of water from the nozzles is too high, and the plumes of fog generated are too small. Thus, the fog is introduced into only part of the airstream and it hopefully eventually mixes with air in parts of the flow stream where no fog was introduced.

Typical commercially available fogging nozzles have flow rates of about one to three gallons per hour and produce plumes of spray that are from about two to six inches in diameter. A typical installation of fog nozzles might require about 0.01 gallons per hour per square inch of duct cross-section. Because of the high flow rate and small plume size, a typical nozzle often puts out about 10 to 20 times that much water per square inch. Therefore, the airflow inside the nozzle plumes quickly reaches saturation and the remaining droplets cannot evaporate until humidity (water vapor) diffuses out of the spray plume volume or dry air mixes with the spray plume. This results in a substantial increase in the time required to evaporate the bulk flow of fog.

The small size of the droplets places a practical limit on the size of the plume of fog from the nozzle because the droplets have very small mass and very little momentum, so they are very quickly turned by the airflow. The result of fogging with typical nozzles in an air duct or in still air is a number of “columns” of fog that travel down the duct with the airflow. Inside these columns of fog, the air becomes quickly saturated, and droplets no longer evaporate into the saturated air. The fog can travel many feet down the duct before gross turbulence in the air stream mixes the droplets with all of the air in the duct. The time required to mix the fog with all of the air increases the overall evaporation time. In other words, if all fog droplets were equally distributed across the air stream, not in densely populated spray plumes, evaporation would be much faster. This requires designing nozzles with lower flow rates than those available on the market today.

Of course it is possible to develop individual nozzles with smaller flow rates, but there are several disadvantages. High among them is that there would be a very large number of nozzles to install and maintain, and the cost of the nozzles and adaptors and the labor required to attach them to the manifold tube could be quite high.

Another advantage of low flow nozzles is that, other factors being the same, they inherently produce smaller droplets. This is because nozzles with higher flow rates have denser populations of droplets near the orifice and droplets of different sizes have different initial velocities. This results in a higher probability of collision and coalescence, which causes the formation of larger droplets. It is common for this effect to result in a substantial difference in the average size of droplets measured near the orifice as opposed to the size measured at 30 centimeters, for instance, downstream from the nozzle orifice. Average droplet size is almost always observed to be larger further from the orifice, even when measurements are taken in a saturated air stream (to remove the effect of the rapid evaporation of very small droplets).

### SUMMARY

There is, therefore, provided in the practice of this invention, a novel tube nozzle having a plurality of holes through the wall of the tube. Each hole is in the range of from about 10 to 200 micrometers in diameter. Each hole has a length through the wall in the range of from about 20 to 400 micrometers. The wall of the tube is locally thinned where the holes are located so that flow losses due to friction and turbulence are minimized and so that the tube maintains sufficient mechanical integrity so as to be capable of delivering water under high pressure to the holes. Such tubes may be used in air ducts or open air.

### BRIEF DESCRIPTION OF THE DRAWINGS

Examples of such a multiple spray nozzle apparatus are illustrated in the accompanying drawings, wherein

FIG. 1 is a view transverse to an air duct,

FIG. 2 is a fragmentary transverse cross-section of a tube,

FIG. 3 illustrates another arrangement of tubes for an air duct,

FIG. 4 is a fragmentary transverse cross-section of another tube nozzle, and

FIG. 5 is a fragmentary transverse cross-section of still another tube nozzle.

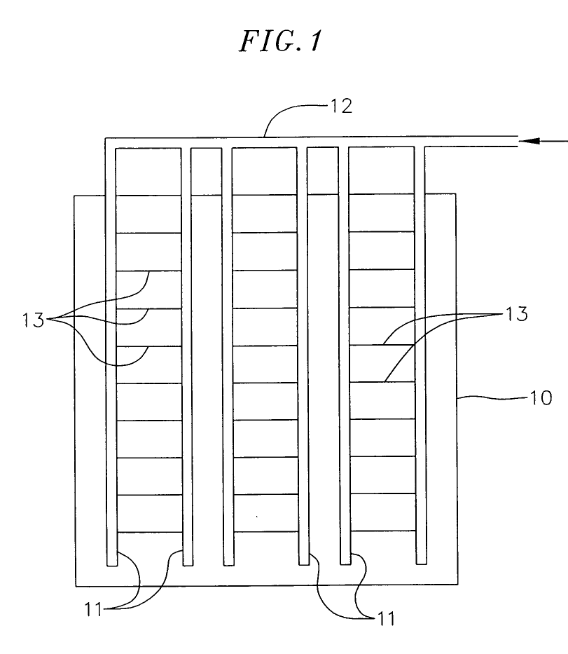

### DETAILED DESCRIPTION

An exemplary air duct 10, which happens to be illustrated as rectangular, has a plurality of pipes 11 arrayed across a cross-section of the air duct. These pipes are connected to an inlet manifold 12, which distributes high-pressure water to the pipes. In this arrangement, a number of short tubes 13 are interconnected between each pair of pipes somewhat in the manner of rungs in a ladder. Collectively the smaller tube nozzles 13 are arrayed across most of the cross-section of the duct.

The tube nozzles may be either vertically or horizontally aligned. Horizontal alignment may be preferred in order to reduce dripping after water flow is turned off. A spring-loaded anti-drip valve, which requires more pressure than that exerted by the column of water present in the manifold, may be employed at the inlet of the tube nozzle or at each orifice to reduce dripping after shut down. Alternatively, an electrically actuated valve may be used to quickly drain the manifold, or a vacuum pump may be used to suction water from the line. A spring-loaded drain valve, designed to open to drain when the pressure in the manifold falls below a predetermined limit, may also be used.

Each of the tube nozzles is typically stainless steel with an outside diameter of about 3 to 8 millimeters. Generally speaking, it is desirable to use smaller diameter tubes and pipes and maximize the spacing between pipes and tubes to minimize the cross-sectional area of the duct that is occulted by the pipes and tubes (and any required supporting frames, braces, etc. which are not illustrated herein). It is desirable to obscure less than 50% of the duct cross-section with the fogging apparatus to minimize pressure drop in the air stream. Ideally not more than 5% to 10% of the duct cross section would be obscured.

The individual tubes are connected to the pipes by conventional threaded or compression pipe fittings, tees, elbows, couplings, unions, nipples, and the like, or joints may be brazed, welded or soldered. It is preferred to include a very fine filter at the inlet(s) to each tube so that any particles that bypass or are generated downstream from a system filter (e.g. shed from pump seals, etc.) are removed before entering the tubes to avoid plugging of the small holes.

The dimensions, including wall thickness, of the tubes should be quite well known so that dimensions of the finished product can be well controlled. A row of pockets 14 are milled along the length of such a tube. Each of these pockets is deep enough that the remaining wall thickness at the bottom of the pocket where the hole is to be formed is about 20 to 200 micrometers. A hole 15 having a diameter in the range of from about 10 to 100 micrometers is formed at the bottom of each pocket. Good smooth-walled holes in this size range can be produced with a burst of laser radiation. Several suitable laser hole making machines are available on the open market. Small diameter holes may also be formed by EDM. In either case, such a hole may have a slightly conical rather than cylindrical shape, preferably with the larger end of the cone being on the inside to facilitate the free flow of water and to reduce turbulence related flow losses. It is preferred that the hole size be in the range of from 20 to 200 micrometers, and the wall thickness is about twice the hole diameter, or about 40 to 400 micrometers. However, it may be desirable to have smaller and deeper orifices in order to control the flow of water from each hole to a limit that results in the desired concentration of water in the spray plume formed by the nozzles.

In an exemplary embodiment, the holes along the length of a tube are in the order of from about 1 to 10 centimeters apart. Individual tubes are generally in the order of from 15 to 50 centimeters long. The tubes along the “ladder” may be spaced apart about 3 to 15 centimeters, keeping in mind that it is desirable to obscure, with the tubes, pipes and fittings, as little as possible of the duct cross-section, but desirable to cover with the fog spray, as much of the cross section of the air flow as possible. It is preferred that the holes and tubes be spaced apart a distance such that the water droplets evaporate before the individual plumes merge or intersect. Excessive intersection of the spray plumes near the tube nozzles before evaporation is undesirable so as to avoid collisions and possible coalescence of unevaporated droplets. Near intersection is desirable to distribute water most uniformly across the transverse cross-section of the air duct. Once all the droplets have attained the velocity of the airflow, the likelihood of coalescence is greatly reduced.

A typical installation has tubes about 6 to 8 or 9 centimeters apart and holes through the tubes about 4 to 8 centimeters apart.

There are a variety of directions for the holes in the tube wall to be aimed relative to the air flow through the duct, and various advantages can be attributed to different orientations. For example, the holes may point directly downstream, and the resulting plumes of fog tend to have limited intersection and coalescence. Generally it is undesirable to have the holes pointing directly upstream, since an appreciable fraction of the water droplets may impact the tubes and not be diverted around the tubes by air flow. Droplets which impact on the nozzle tubes will collect and be stripped off as larger droplets by the air flow. For water, the size of droplet formed is, in general terms, a function of the air flow velocity and the geometry and dimensions of the tube. Conversely, pointing the nozzle holes directly upstream can be desirable since it may aid mixing and slightly adds to the residence time for the fog in the air stream. In this case nozzles with a split spray plume could be employed such that none of the water impacts on the tube.

Holes may be directed transverse to the air flow through the duct, in which case somewhat wider spacing between individual tubes may be feasible. A desirable arrangement may have individual holes pointing diagonally upstream (e.g., at about 30 degrees) for the benefits of counter-flow and wider tube spacing.

The desired orientation of the holes may differ for different installations depending on the velocity of air flow, the amount of water required, etc., and different orientations may even be used in different portions of an air duct for enhanced uniformity of water distribution. It may also be desirable to space the tube nozzles to avoid fog impaction on downstream obstructions in the ducts or to account for the fact that the evaporative cooling of the air will cause it to fall (i.e., more fog output at the top of the duct, less near the floor).

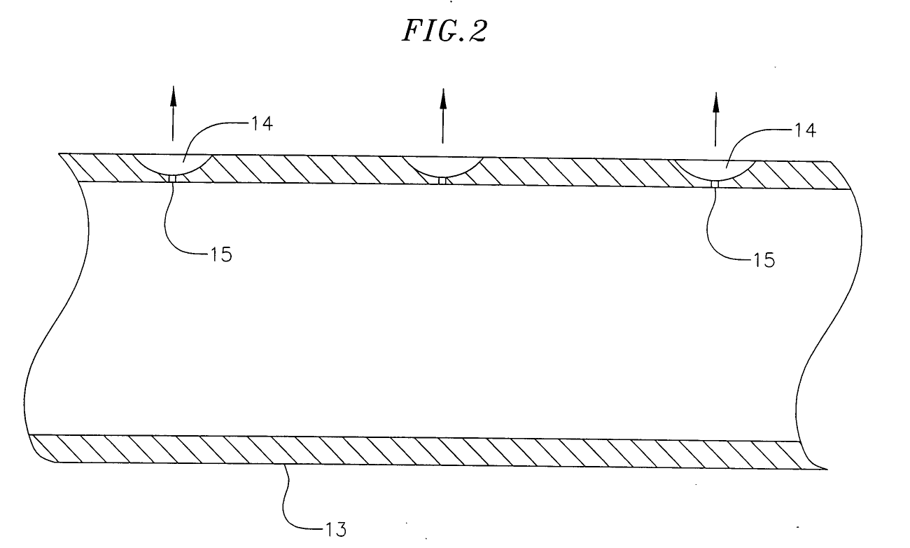

In the illustration of FIG. 2, holes are provided along one side of the exemplary tube. It may be desirable to provide holes along opposite sides of the tube, particularly if the holes are directed transverse to the direction of air flow. The holes may be in rows with holes aimed diagonally upstream (or downstream). One desirable arrangement may include two rows of holes pointing diagonally upstream and a third row of holes pointing directly downstream. The holes in the separate rows and tubes may be offset from each other to minimize intersection of plumes of fog. Alternatively, they may be directly opposite each other to enhance full coverage of the duct cross section. Small droplets take the velocity of the air stream in a very short distance from the nozzle. If the droplets are all traveling at the same speed, they tend not to collide.

Additional information concerning nozzle orientation, droplet size, dynamics and coalescence, nozzle types, use of nozzles in air ducts and other information may be found in a series of technical papers entitled “Inlet Fogging of Gas Turbine Engines” by Mustapha Chaker, Cyrus B. Meher-Homji and Thomas Mee III, ASME Paper Numbers 2002-GT-30562, 2002-GT-30563 and 2002-GT-30564 (2002). The subject matter of these papers is hereby incorporated by reference.

Individual pockets for each hole is just one example of how the wall of the tube can be locally thinned adjacent to each hole. The illustrated pockets may be milled with a circular milling cutter with its axis transverse to the length of the tube. The center of such a counterbore leaves a thinner wall section than near the edges to help maintain tube strength. Many other arrangements will be quickly apparent, including ball end mills, flat end mills or conical end mills (drills), which effectively counter-bore the holes through the thinned wall. A milling cutter or the like might make a cut transverse to the tube length to leave a thinned wall. The resulting groove may be flat on the bottom, rounded or V-shaped. One may also mill a flat or groove along the length of a tube, for example. Swaging may also be used for local thinning of the tube wall. Special tube extrusions may be used where a longitudinal strip of the wall is extruded thinner than the rest of the wall. This thinned portion could be on either the inside or outside of the tube. About the only limitation on how the tube wall is thinned to control length of the holes is that it is preferred to avoid interference between a stream of water from the hole and any portion of the tube wall where it is not thinned.

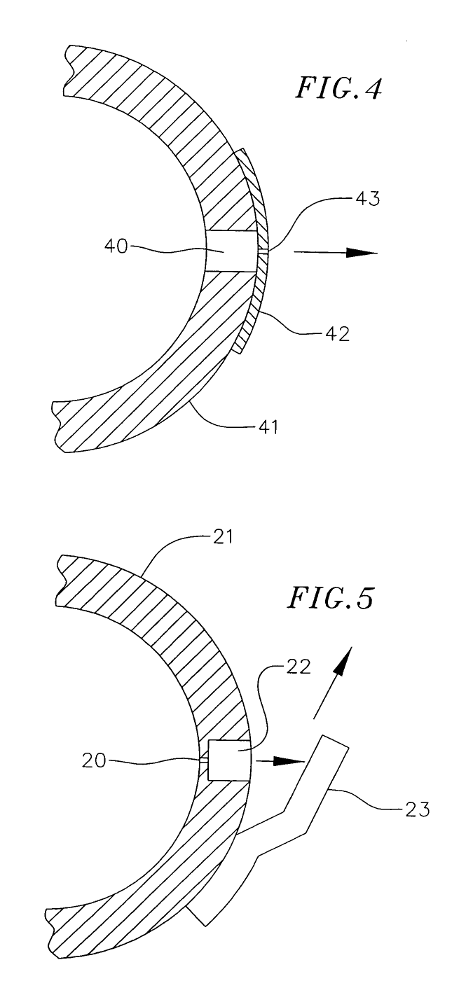

Alternatively, holes through the wall of a tube may be formed in a “patch” as illustrated in FIG. 4. In this embodiment of the tube nozzle, a relatively large hole 40 is drilled or otherwise formed through the wall 41 of the tube. A small patch 42 of compatible metal is secured over the hole, such as by spot welding, electron beam welding, laser welding, brazing, cementing or any other suitable technique which will resist internal water pressure. The patch may be square, round or oval, or any other suitable shape large enough to overlap the edges of the large hole. A small hole 43 through the patch serves as a nozzle through which water is ejected to form fog droplets.

The patch may also be a small nozzle device, such as a swirl-jet nozzle or an impaction pin type nozzle.

Thus, the diameter of the small hole is in the range of from about 10 to 200 micrometers and preferably in the range of from about 50 to 100 micrometers. The thickness of the patch may define the length of the nozzle or may itself be locally thinned such that the hole depth is in the range of from about 50 to 400 micrometers and preferably in the range of from about 100 to 200 micrometers.

The small hole in the patch may be formed either before or after the patch is secured to the tube. If it is formed before placing the patch on the tube, there is an opportunity to make the small hole as part of a conventional swirl-jet or impaction-pin type nozzle, in which case the patch can have a thickness larger than for a straight hole nozzle. If the small hole through the patch is formed before placing the patch on the tube, it is also easier to make the hole converging conical for reduced flow resistance.

Impact of a jet of water from a hole through the tube wall may be desirable in some cases. Such an arrangement is illustrated in FIG. 5, where a small hole 20 is made through a wall 21 of a tube near the bottom of a suitable counter-bore 22. An impact plate 23 is spot-welded or otherwise attached to the side of the tube so as to have an impact surface opposite the hole. A jet of water through the hole impacts on the plate and shatters into a generally fan-shaped spray of fine droplets. An impact surface on the end of a J-shaped impact pin may be aligned with the hole to produce a 360-degree spray of water droplets. It will be apparent that an impact surface may be placed on a patch as described above, instead of directly on the tube wall.

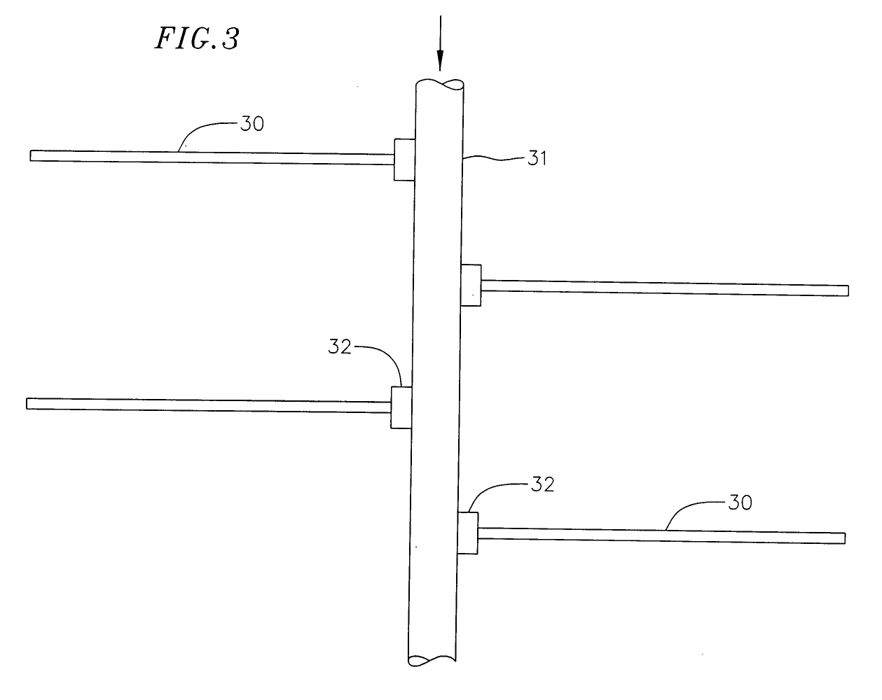

FIG. 3 illustrates another arrangement of tubes 30 on a pipe 31 which can be built into an air duct. In this embodiment, a plurality of tubes are connected along the length of the pipe so as to extend laterally from the pipe on both sides. Each of the tubes is attached or welded to a small filter housing 32 for a fine filter to prevent particles from plugging the very small holes through the tube. Such an arrangement can be advantageous since it is quite easy to assemble by simply threading the filter housings directly into the wall of the pipe 31 or a fitting on the pipe.

The flow of water per square inch of duct cross section is designed for the particular application and air flow rate. If, for instance, 30° F. of evaporative cooling is required in an exemplary gas turbine inlet air duct with an air flow velocity in the duct of about 2500 feet per minute, the flow required per square inch is about 0.065 gallons per hour.

Exemplary prior nozzles operated at 2000 psi water pressure produce a narrow plume having about 0.38 gph/in², or nearly six times what is needed. Thus, the plumes have to be spaced apart to achieve an average flow of 0.065 gph/in², and there would not be ideal mixing of the fog in the air stream, resulting in a longer time required to evaporate the water and a larger average fog droplet size when the fog enters the gas turbine compressor.

Similarly, if 30° F. of evaporative cooling is required in an exemplary HVAC air duct with an air flow velocity in the duct of about 500 feet per minute, the flow required per square inch is about 0.012 gallons per hour. Exemplary prior nozzles at 2000 psi produce a wider plume having about 0.21 gph/in² of water flow, or more than about 17 times the fog needed. (The plumes are wider since the fog ejected is not as rapidly turned downstream by the slower flow of air.) Thus, the nozzles need to be spaced even further apart to achieve the desired average.

The description herein has concentrated on use of tube nozzles in ducts with a flow of air. The novel tube nozzles may also be used indoors or outdoors in relatively still air. For example, tube nozzles a meter to several meters long (with diameters from about 5 to 20 mm) may be used in humidification and/or cooling systems for factories, greenhouses or outdoor cafes. (Shorter tube nozzles are generally preferred in air ducts to minimize distortion and/or vibration due to fast air flow.)

A humidification system in a room may, for example, use tube nozzles three to seven meters long arranged three or four meters above the floor with holes spaced from about 20 cm to one meter apart. Such a system should have the tube nozzles mounted high enough to assure complete evaporation before water droplets reach the floor or the top of machines, etc., that may be inside the room. Many distributed nozzle holes are desirable to minimize localized evaporative cooling where the cooled air falls rapidly, taking water droplets with it and wetting machines, etc.

Long tube nozzles may also be used for special effects where widely distributed fog without large, noticeable, spray plumes is desired. They may also be quite useful and economical for outdoor patio cooling.

Referring again to use of tube nozzles in air ducts; one may place a sheet metal “wall” upstream from a nozzle manifold. Holes in the wall direct turbulent air into the nozzle spray plumes so that all the air is forced to mix with all of the fog. Such a wall may be used with either the tube nozzles or with conventional impaction pin or swirl-jet nozzles.

Gas turbines have trash screens, wire mesh screens that are installed upstream from the compressor, that are designed to catch any foreign objects that might be in the air stream. The small diameter wires in the trash screen are excellent collectors of fog droplets, because the small cross section of the wires makes it difficult for droplets to follow the air flow around them. This effect results in the coalescence of the fog droplets and large droplets are shed from the trash screen. Installing conventional fog nozzles downstream of the trash screen is often not practical because it is often too close to the compressor. Furthermore, many operators may desire to locate the nozzles upstream of a trash screen so that any piece that may break off the nozzle array is caught by the trash screen and not ingested by the compressor, which could cause a mechanical failure of the compressor. A tube nozzle manifold could be integrated with such a trash screen to take the place of a conventional trash screen, thus, eliminating a source of large droplets. The tube nozzles may themselves be arrayed close enough together, with additional “inert” rods between tube nozzles, to become an effective trash screen. A wire-mesh trash screen could also be installed at the nozzle array so that the fog spray plumes do not strike the wire mesh but such that the nozzles themselves cannot pass through the screen mesh. But combining the trash screen with the tube nozzle array would be a more economical approach.

The amount of water that is sprayed by the fogging system can be regulated by varying the pressure of water introduced into the tubes. Raising the pressure increases the flow rate through the holes. This has the advantage of keeping uniform distribution of droplets in the air but the disadvantage of producing larger droplets at lower pressures. Also, one may employ separate manifolds of tubes so that water fog is ejected from selected numbers of tubes to control the total water introduced by simply turning off some of the manifolds. This has the disadvantage of non-uniform distribution of droplets in the air, but the advantage of consistently small droplets. A combination of turning on and off selected numbers of tubes and varying the operation pressure could be used to regulate the amount of water sprayed.

Some manifolds might be operated at higher pressure while others are at lower pressure in another part of a duct where air flow is not uniform in all parts of the duct. A similar effect may be achieved by varying the hole and/or tube spacing in different parts of a duct cross-section. The selection of which technique to use indoors or outdoors or in an air duct will depend on the specific requirements of the application. In some cases a combination of more than one technique may be desirable.

Using an array of tube nozzles in an air duct permits close enough spacing of nozzles to achieve good mixing of ejected fog with substantially all of the air flowing through the duct within a very short distance from the nozzles. The tube nozzles are spaced close enough together and the holes through the tube walls are close enough that at least 80% of the air flowing through a cross-section of the duct is mixed with ejected fog within about one half meter of the nozzles.

This is not economically feasible with conventional individual nozzles for a variety of reasons, not the least of which are that the number of nozzles needed is expensive, and the flow rate through individual nozzles is too high for nozzles to be more closely spaced without introducing too much water. Typically, only about 30% of the cross section has plumes of fog droplets mixed with air as much as a meter downstream from the nozzles.

With current systems for introducing fog droplets into a gas turbine or HVAC duct, mixing of plumes of fog with most of the air does not occur closer than about two to seven or eight meters down the duct from the nozzles. Since droplets cannot evaporate into saturated air, the time for complete evaporation of the droplets is unduly prolonged. This time is significantly shortened when fog droplets are mixed with at least 80% of the air within about one half meter of the nozzles. Much more uniform and efficient cooling and/or humidification is achieved, particularly when the downstream distance from the nozzles is short.

It is desired to mix fog droplets with at least 80% of the air flowing through the cross section since it may be desirable to avoid spraying fog too near the walls of the duct, thereby minimizing impact of droplets on the walls and the resulting water that must be drained away to waste.

The spacing of tube nozzles and holes through the tube walls to achieve 80% mixing within one half meter will depend on a variety of factors, principally air flow rate. Closer spacing is needed for higher velocity air flow (other factors being equal) because the fog plumes are narrower in high velocity flow than in low velocity flow. Other factors include the angle of introduction of the spray of droplets relative to the direction of air flow, water pressure, droplet size, total desired cooling or humidification, and upstream devices (such as a perforated wall as described above) for promoting mixing. Papers published in the technical literature show that one skilled in the art of fog systems for humidification and/or cooling can readily determine approximate or accurate spacings, and if desired these determinations can be verified in a small wind tunnel as described in the ASME papers mentioned above.

The drawings have not been prepared to scale. The individual pipes, tubes and holes may be closer or further apart than might appear from the drawings, as suggested by the dimensions mentioned above. Thus, the drawings can be considered semi-schematic and merely exemplary.

1. A multiple spray nozzle apparatus comprising:
a plurality of humidifying tubes, each tube comprising:
a tube,
a plurality of holes through a wall of the tube, each hole being in the range of from about 10 to 100 micrometers diameter, and
each hole having a length through the wall in the range of from about 20 to 200 micrometers; and
means for introducing high pressure water into each tube.

2. Apparatus according to claim 1 wherein each hole has a diameter in the range of from about 20 to 200 micrometers and each hole has a length through the wall in the range of from about 40 to 400 micrometers.

3. Apparatus according to claim 1 wherein the tubes are arrayed across the cross section of an air flow duct, and further comprising means for passing a flow of air through the duct.

4. Apparatus according to claim 1 wherein the wall of the tube is locally thinned adjacent each hole.

5. Apparatus according to claim 4 wherein the local thinning of the wall comprises a larger hole through a wall of the tube and a smaller hole through a patch secured to the wall of the tube.

6. Apparatus according to claim 1 comprising a water delivery manifold and wherein at least a portion of the tubes are arranged between a pair of water supply pipes of the manifold.

7. Apparatus according to claim 1 comprising a water delivery manifold and wherein at least a portion of the tubes extend laterally from a water supply pipe of the manifold.

8. Apparatus according to claim 1 comprising a water delivery manifold and wherein at least a portion of the tubes extend laterally from opposite sides of a water supply pipe of the manifold.

9. Apparatus according to claim 1 comprising an impact surface outside at least a portion of the holes.

10. A multiple spray nozzle apparatus comprising:
a tube,
a plurality of holes through a wall of the tube, each hole being in the range of from about 10 to 100 micrometers diameter, and
each hole having a length through the wall in the range of from about 20 to 200 micrometers.

11. Apparatus according to claim 10 wherein each hole is in a thinned portion of the tube wall.

12. Apparatus according to claim 10 wherein the wall of the tube is locally thinned adjacent each hole.

13. Apparatus according to claim 10 wherein each hole is in the bottom of a counterbore in the tube wall.

14. Apparatus according to claim 10 wherein each hole is in a patch on the tube wall, the patch being thinner than the tube wall.

15. A multiple spray nozzle apparatus comprising:
a plurality of humidifying tubes arrayed across a cross section of an air duct, each tube comprising:
a tube, and
a plurality of holes through a wall of the tube, the holes being sufficiently small to emit fog droplets; and
means for introducing high pressure water into each tube, wherein the tubes and holes are sufficiently close together for mixing fog droplets from the holes with at least 80% of the air flowing through a cross section of the duct within about one half meter downstream from the holes.

16. Apparatus according to claim 15 wherein each hole is in a thinned portion of the tube wall.

17. Apparatus according to claim 15 wherein the wall of the tube is locally thinned adjacent each hole.

18. Apparatus according to claim 15 wherein each hole is in the bottom of a counterbore in the tube wall.

19. Apparatus according to claim 15 wherein each hole is in a patch on the tube wall, the patch being thinner than the tube wall.

20. A multiple spray nozzle apparatus comprising:
a tube,
a plurality of holes through a wall of the tube, each hole being in a locally thinned portion of the hole wall.

21. Apparatus according to claim 20 wherein each hole is in the bottom of a counterbore in the tube wall.

22. Apparatus according to claim 20 wherein each hole is in a patch on the tube wall, the patch being thinner than the tube wall.

23. A multiple spray nozzle apparatus comprising:
a tube;
a plurality of larger holes through a wall of the tube;
patch on the tube wall covering each larger hole, each patch being thinner than the tube wall; and
a smaller hole through each patch.

24. A multiple spray nozzle apparatus comprising:
a tube;
a plurality of counterbores in the tube wall; and
a hole through the tube wall at the bottom of each counterbore.

25. A multiple spray nozzle apparatus comprising:
a tube;
a plurality of patches on the tube wall, each patch being thinner than the tube wall; and
a hole through the patch.
